(19) United States
(12) Patent Application Publication
(10) Pub. No.: US 2013/0232431 A1
(43) Pub. Date: Sep. 5, 2013

(54) SYSTEM AND METHOD FOR MANAGING AND DELIVERING MEDIA CONTENT ON A WEIGHING SCALE

(71) Applicant: Brian Hipsher, Worthington, OH (US)

(72) Inventor: Brian Hipsher, Worthington, OH (US)

(73) Assignee: METTLER-TOLEDO, LLC, Columbus, OH (US)

(21) Appl. No.: 13/412,437

(22) Filed: Mar. 5, 2012

(51) Int. Cl. G06F 3/048

(52) U.S. Cl. 715/771

(57) ABSTRACT

A method for selecting and presenting selected media content to a consumer via a consumer display screen of a PC-based weighing scale. A scale operator is able to call up desired media content and is then permitted to select a particular portion(s) of the media content from a list of available media content responsive to the request. Upon selection, the selected media content is pushed to the consumer display screen where it replaces the content currently appearing thereon. As a transaction takes place on the scale, relevant/necessary information is presented on the consumer display screen without interruption or a reduction in size of the selected media content display. The information is presented in a built-up fashion that maximizes the amount of the consumer display screen available for presenting the selected media content.

### BACKGROUND OF THE INVENTIVE FIELD

The present invention is directed to providing targeted media content to a consumer via an in-store weighing scale. More particularly, the present invention is directed to a weighing scale based system and method that allows a scale operator to select and deliver media content to a consumer via the weighing scale.

It is well known that manufacturers and retailers employ various techniques to bolster sales and influence shopping behavior. For example, numerous types of coupons and other incentives may be received by consumers relating to any number of products. Similarly, product advertisements regularly appear in newspapers, or may be sent to consumers via direct mailing.

Advertisements and incentives appearing in newspapers or sent by direct mail are an attempt to influence shopping behavior of the general public, and are not, and generally cannot be, tailored to an individual consumer. Consequently, point-of-sale (POS) advertisements, incentives, etc., may be used to focus on specific consumers. These techniques typically focus on a product(s) purchased by a consumer on a given day (as identified by a POS device), and/or by the purchase history of the shopper (as determined, for example, from a frequent shopper card). As such, a consumer may be offered a printed coupon at check out, such as on a sales receipt or on a separately printed advertisement that is also presented to the shopper. Unfortunately, since such coupons and advertisements are directed to future purchases by the consumer, such techniques are generally not effective at influencing shopping behavior in real time.

Therefore, techniques that are capable of influencing shopping behavior in real time have also been introduced. A primary example of such a technique involves exposing a consumer to advertising, incentives, etc., prior to the consumer reaching a checkout area of an establishment. Such a technique is particularly applicable to consumers shopping in a specialty department of a retail establishment such as, for example, a bakery, or a meat or fish department. These techniques may be particularly effective in such areas because selected information can be presented to a consumer while a product selected by the consumer is processed on a weighing scale or while the consumer searches for product information at a kiosk or similar device.

Because weighing scales, kiosks and similar devices are typically encountered by a consumer, it is more likely that advertisements, incentives or other information presented thereby may influence the consumer's behavior while still within the shopping area of an establishment. For example, when a consumer selects a product that must be weighed, the weighing scale employed for such purpose may be simultaneously used to provide the consumer with information that will prompt the consumer to buy more of that product, and/or to buy a related or complimentary product. For example, a PC-based scale may be programmed to automatically display an advertisement, an incentive or other media content based on a product presented to the scale by or on behalf of the consumer. These displays of information may be multimedia presentations comprising a slide show of photos or a non-static video, either of which may also include audio.

One problem associated with such multimedia presentations, however, has been the inability to utilize a weighing scale operator or other store employee to manage and deliver media content (which may include without limitation nutritional information, a recipe, a coupon, an advertisement, etc.) to a consumer. Rather, current systems rely on an automated means of selecting and displaying media content, such as selecting content to display that is related in some fashion only to the product presented to the scale or to a product that is complimentary to or otherwise related to the product.

One reason for this is that while employees of a given department (e.g., a fresh department of a supermarket) are expected to be experts about the products they offer, employee turnover, and the broad array of products available create a challenge with regard to adequately training store staff and maintaining a roster of trained staff. Another problem has been that accessing and displaying on a weighing scale a particular piece of information requested by a consumer has heretofore been somewhat difficult and time consuming—typically requiring the scale operator to read through a multitude of product information to locate the particular information requested by the consumer.

It is recognized that such media content may be best displayed for the consumer on a consumer-facing screen rather than the consumer having to rely completely on the employee repeating the information he or she has retrieved on the operator side of the scale display. Displaying the media content directly to the consumer boosts the consumer's confidence in the information.

One factor complicating the direct display of information to a consumer is that consumer-facing displays associated with modern weighing scales are typically also used to display legal for trade weight information and also for displaying promotional advertisements, etc. The advertisements often play continuously. Consequently, the advertisement would need to be interrupted in order to display other media content. Displayed weight information would also likely need to disappear or be minimized.

Another complicating factor with respect to displaying media content on a consumer-facing display of a weighing scale is that the consumer-facing displays of most weighing scales continuously display necessary weights and measures information—even when it is not necessary to continuously display such information. Such weights and measures data can take up valuable space that could otherwise be utilized to display desired media content.

There is a need, therefore, for a system and method that allows a weighing scale operator or another employee of a given department to selectively deliver media content to a consumer in real time via a weighing scale or a similar device. With respect to weighing scales, there is also a need for a system and method that permits the display of video and other media content while also being capable of presenting the consumer with the weight of the product placed on the scale, as is required by law, and possibly with other information related to the scale transaction, with minimal interruption to or minimization of the displayed media content. The present invention is such a system and method.

### SUMMARY OF THE GENERAL INVENTIVE CONCEPT

The present invention is directed to a system and method that allows a scale operator or other employee to selectively deliver media content, such as product information, nutritional information, recipes, advertisements, etc., to a consumer via a weighing scale display. The media content may be displayed to a consumer in real time as the consumer is exposed to the weighing scale, and the media content may be based on, for example, an inquiry from the consumer (e.g., nutritional information, a recipe, etc.), an employee observation about the consumer, or a product selected by or of interest to the consumer. The media content may take many forms, such as simple text or more complex graphic, video and/or audio presentations.

The present invention makes use of modern PC-based scales that make it possible to display information about a product to store employees (e.g., scale operators) in a real time fashion via a scale operator screen. The use of a properly programmed PC-based scale also makes it possible and much easier for an employee to look up information pertinent to a consumer request. To facilitate the ability of a scale operator to quickly find desired product-related information, the information may be grouped into packets or folders that may then be presented to a scale operator in a simple categorical list or in another format that simplifies the location and selection of desired information, such as through the use of selection buttons. This allows a scale operator to easily locate specific information of interest instead of having to sort through the entirety of the information available about a given product.

As an example, a customer visiting a deli department may want to know if a particular salad contains nuts because of an associated allergy. The present invention allows an employee to quickly and easily look up the requested information using the operator display of the weighing scale and to display information relative to the consumer query on a consumer-facing display of the scale. The employee may also cause other types of media content to appear on the consumer-facing display, such as, but not limited to, nutrition facts, ingredients, preparation instructions, recipes, pairings, product origin, manufacturer information, customer surveys, etc.

Operator interfaces of the weighing scale may be variously designed to allow for media content access. For example, a main screen of a weighing scale may be provided with a media content access button that, when selected by a scale operator, takes the operator to a media content selection screen where various media content relating to a given product may be accessed. As mentioned above, the information associated with the media content may be categorized or otherwise listed in a manner that facilitates the selection of particular types of information. Other operator interface designs are certainly also possible, as would be understood by one of skill in the art. For example, a main operator screen may include a dedicated area via which media content may be accessed. In such a case, a dedicated media content access screen may be unnecessary.

To help ensure that the most comprehensive, up to date and accurate information is being pushed to a consumer, the product-related information from which a scale operator or other employee may select is preferably updated at certain intervals or when new information is available. In this regard, a scale used with the present invention may include or be associated with a content management system (CMS) that operates to obtain and/or update product information.

Because some media content, particularly graphic and video media content, may be of substantial file size, it is preferable that media content (i.e., product-related information) be stored locally at the scale or in a database that can be quickly accessed by the scale (such as by a LAN, WAN, etc.). In other words, while remote media content storage is possible, it is preferable that the media content not be streamed in real time over the Internet each time a scale operator makes a data request (although some streaming is possible).

To this end, the CMS preferably updates media content periodically. For example, the CMS may be adapted to search one or more media content download locations at some predetermined time or time interval. Alternatively, a media content storage location may signal a scale, either directly or via an associated CMS, when new or updated media content is available. The CMS may subsequently act to download the new or updated media content and make the media content available to the relevant scale(s) with which it is associated. In the case of updated media content, the CMS may also directly or indirectly cause outdated media content to be removed from a scale(s). This CMS activity may occur during store hours, or during off-hours to help avoid service interruptions that might be caused by bandwidth heavy downloads and/or uploads to a scale(s).

It should be realized that localized media content storage is preferable, real time streaming is not impossible. Consequently, it may be possible for some or all of the displayable media content from which an employee can select to be stored and managed remotely from a given weighing scale. Thus, when a product is identified to a weighing scale or a weighing scale identifies a given product (such as by its PLU number), the weighing scale signals the remote media content storage device, which thereafter delivers the relevant media content to the weighing scale for display to a user. As discussed above, the obvious downside to this procedure is the risk that download speed may render certain media content unavailable within a reasonable time of its request. This may change as file transfer protocols allow for smaller file sizes and Internet download speeds further increase.

The CMS may also manage the stored media content to ensure that proper files are associated with the correct PLU numbers. Management may also include selecting a best media file from a group of media files that may be applicable to a given PLU number.

Systems and methods of the present invention also ensure the best possible use of the consumer-facing display of a weighing scale. Particularly, the present invention operates to maximize the viewing area of the display at all times. This is accomplished by utilizing a build-up of information rather than displaying all possible content at one time. In this manner, only necessary information is displayed.

More specifically, when a weighing scale operator or other store employee acts to present selected media content on a consumer-facing display of a weighing scale according to the present invention, the scale allows any media content or other information currently being presented on the operator side of the scale display to be interrupted on demand. The present invention further allows the content selected for display by the scale operator to be substituted for the existing media content being presented on the consumer-facing display of the scale.

The selected media content will generally remain on the consumer-facing scale display until the scale operator determines it is no longer needed by making a selection on the operator side of the scale. At this time, the scale operator may select a new piece of media content for presentation on the consumer-facing display. Alternatively, the consumer-facing display may revert to the presentation of the previously displayed media content or some other default media content after passage of a certain amount of time.

The present invention also contemplates a method whereby only a zero indicator (as required by law) is observable on the consumer-facing display during times when there is no weight on the scale. When a weight is placed on the scale, the zero indicator is replaced with an active weight value (also required by law). Alternatively, additional (e.g., weight) information may be added to the display alongside the zero indicator. When a PLU is selected or a product is otherwise identified, additional information may be further added to the display (usually price per unit of measure, total price, the product name, any discount offer for the product, etc.). In any event, however, only relevant information is added to the display, and only at the moment it is needed. In this manner, the space where these items of information would otherwise be displayed can be used to display other media content.

Contrarily, when a PLU screen or another screen that has caused a display of information to appear on the consumer-facing display is exited, the information specific to that screen will disappear from the consumer-facing display. If the product (weight) is removed from the scale, the entire consumer-facing display screen may return to its idle state (displaying only a zero indicator) and any selected or default media content. In this manner, the area of the consumer-facing display screen that is available for presenting media content can again be maximized.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIGS. 1A-1B depict an exemplary weighing scale with an operator display screen and a consumer-facing display screen that may be used in the present invention;

FIG. 2A depicts an exemplary operator display of an exemplary weighing scale showing a default display screen;

FIG. 2B illustrates how the default operator display of FIG. 2B is interrupted when media content information is requested;

FIG. 3A is an enlarged view of the consumer-facing display of the exemplary weighing scale of FIGS. 1A-1B;

FIG. 3B illustrates how the default consumer-facing display of FIG. 3B is replaced with media content selected by the scale operator;

FIGS. 4A-4C illustrate how other necessary/relevant information may be added in steps to a consumer-facing display on which is already being presented some type of media content; and

FIG. 5A is illustrates how yet additional media content related to a particular product may be selectively pushed to the consumer-facing display of the exemplary weighing scale of FIGS. 1A-1B; and

FIG. 5B shows how the media content display of FIG. 5A may be changed as a result of a consumer pressing a particular option selection button provided on the consumer-facing display screen.

### DETAILED DESCRIPTION OF EXEMPLARY EMBODIMENT(S)

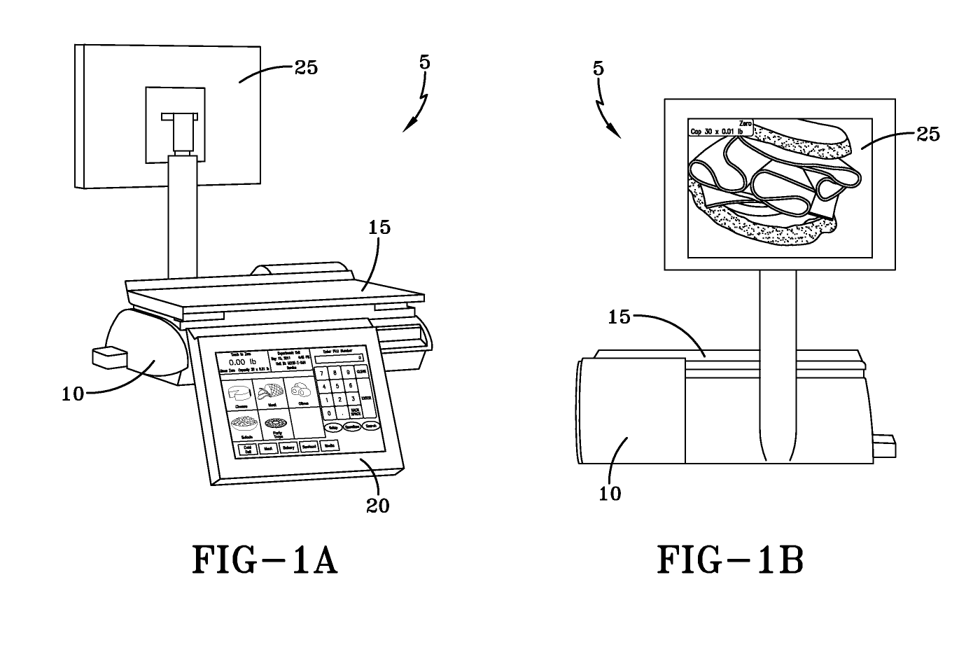

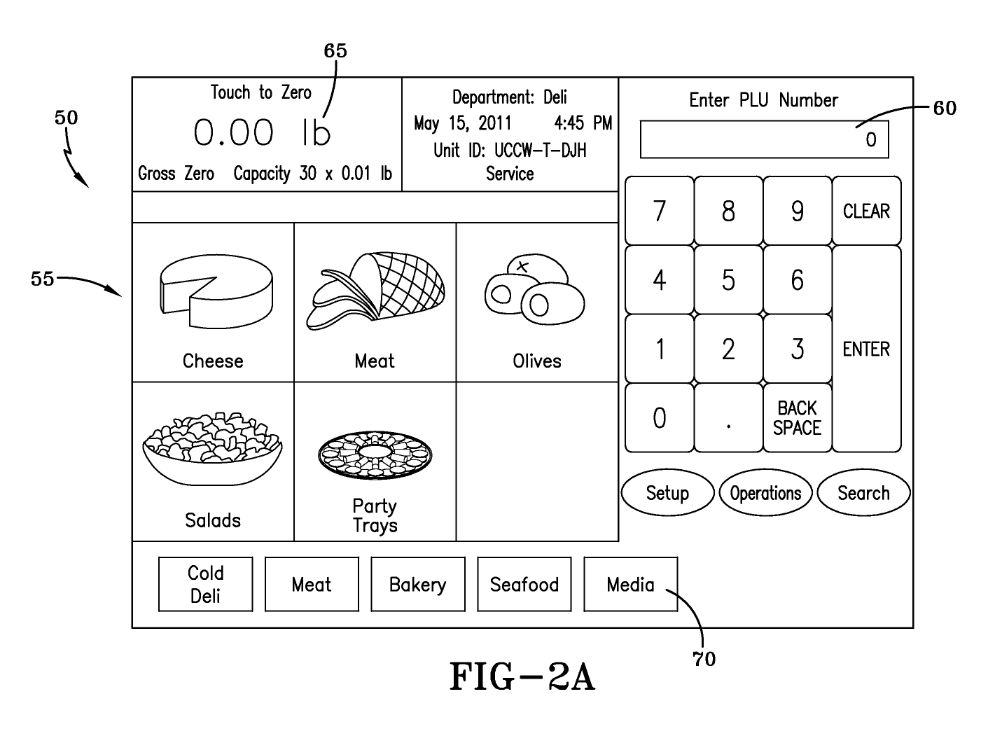

One exemplary embodiment of a PC-based weighing scale (scale) 5 that may be used in the present invention can be observed by reference to FIGS. 1A-1B. As shown, the scale 5 includes a body portion 10, and a weigh pan 15 that rests upon one or more subjacent load cells (not visible). PC-based weighing scales typically also include a microprocessor, an operating system (scale software application), memory, one or more displays, and an input means. Such scales may also include wired or wireless networking ability and/or a label printer. The display screen(s) of such a scale may be a touch screen.

The particular scale 5 depicted in FIGS. 1A-1B is designed for use by a store employee, such as in a deli department thereof. Such a scale is often generically referred to as a “counter service scale.” The scale 5 is provided with two displays 20, 25. In use, the scale 5 is generally positioned on a counter or other surface, such that an operator display 20 will face the employee while a consumer-facing display (or consumer display) 25 faces away from the employee and toward a customer.

The various detailed constructions and features of a PC-based weighing scales that may be used with the present invention would be quite familiar to one of skill in the art and, consequently, no further description is required herein. One skilled in the art would also understand that the PC-based weighing scale 5 of FIGS. 1A-1B is merely an exemplary embodiment of such a scale, and various other designs may exist and be used in conjunction with the present invention. For example, and without limitation, the overall shape of such a scale may be significantly different, the relative size of one or both displays may differ, etc.

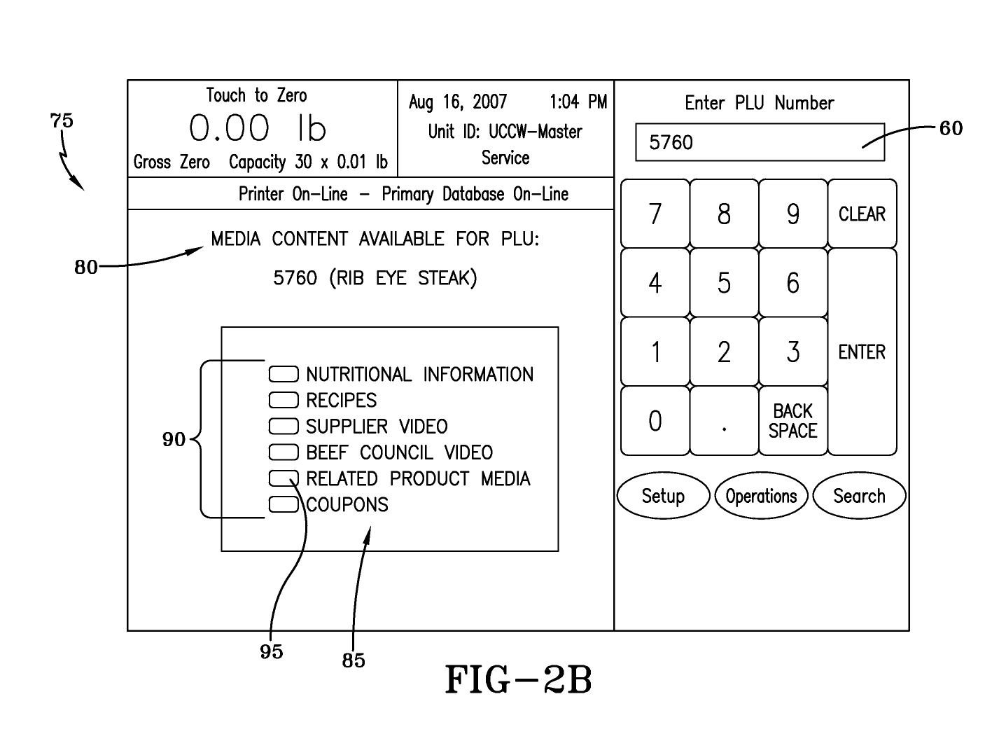

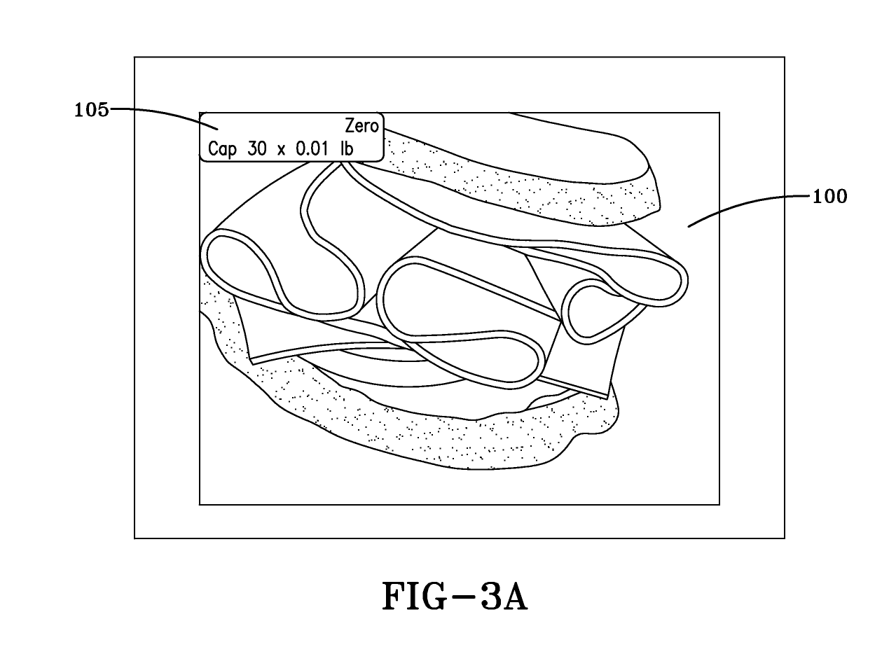

One exemplary embodiment of a typical default display screen 50 that may appear on an operator display of a PC-based weighing scale is shown in FIG. 2A. This particular display screen offers various product categories 55 (e.g., meat, fish, deli, fruits, vegetables, bakery) for selection and may provide an area 60 for entry of a product price look-up (PLU) code, stock keeping unit (SKU) code, and/or some other product identifying information. A product weight display area 65 and/or various other information may also be presented. As shown, a media content request button 70 is also presented to allow an operator to request that media content be transmitted to the scale or called up from a data storage device of the scale. While the display screen 50 is shown for purposes of illustration, it would be obvious to one skilled in the art that such screens may be infinitely variable as to their general appearance and/or to the information displayed thereon. For example, a default operator screen may display a slide show of graphics, a video presentation, store-related messages, etc., instead of a screen like that shown in FIG. 2A. Therefore, it is to be understood that the particular display screen shown in FIG. 2A is provided for purposes of illustration only.

One exemplary embodiment of a media content selection screen 75 that may appear on an operator display of a PC-based weighing scale is shown in FIG. 2B. Such a screen may interrupt the previously displayed screen of FIG. 2A after an operator has requested media content, such as by using the “Media Content” request button 70 shown in FIG. 2A. In this particular case, the operator has also entered a PLU number in the PLU code entry area 60, which indicates to the scale that the operator wants to call up available media content for rib eye steak.

Once the operator has requested media content, such an operator display screen 75 may be used to selectively present available media content to a scale operator. In this particular and non-limiting example, the media content presentation includes a header 80 that identifies a particular product with which the available media content is associated. In this example, the available media content is presented in a simple categorical list 85 that includes selection buttons 90 usable by the operator to select from the list of available content. It should be realized that a lesser or greater amount of media content may be available for other products. When the amount of media content available for a given request exceeds the display area of the display screen, the list of media content may be presented on additional screens and appropriate selection buttons or other means may be provided to navigate therebetween. This may frequently be the case if an operator chooses to see a list of all available media content without restriction to content related in some way to a particular product or product PLU. It should also be realized that the media content available in regard to a given request may be presented as other than a text list. For example a graphical display or a combined text/graphics display may be used and may utilize icons, tiles and other display techniques.

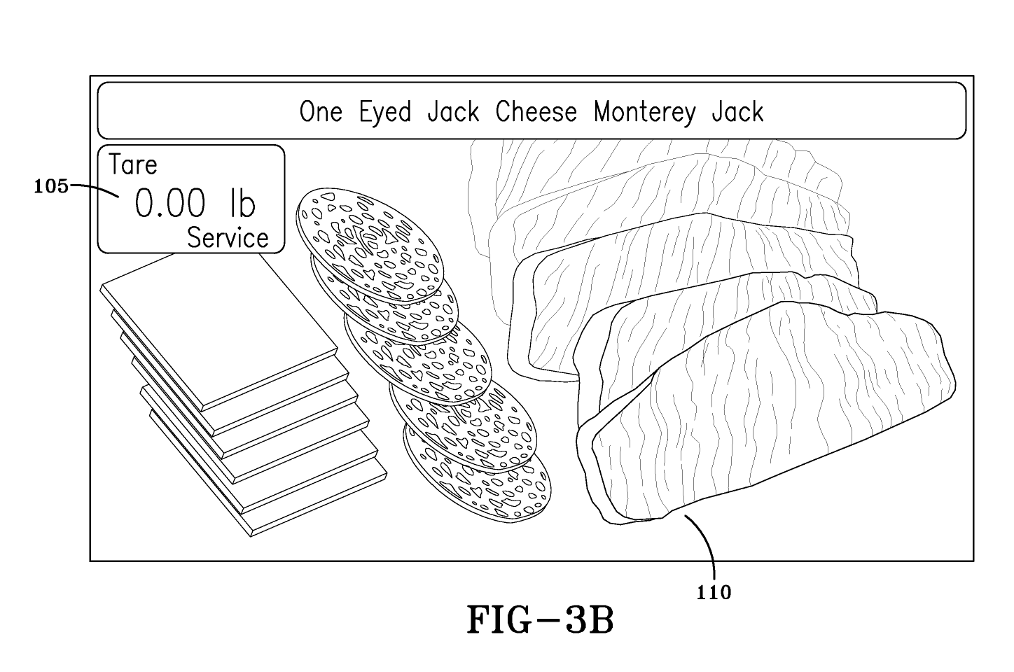

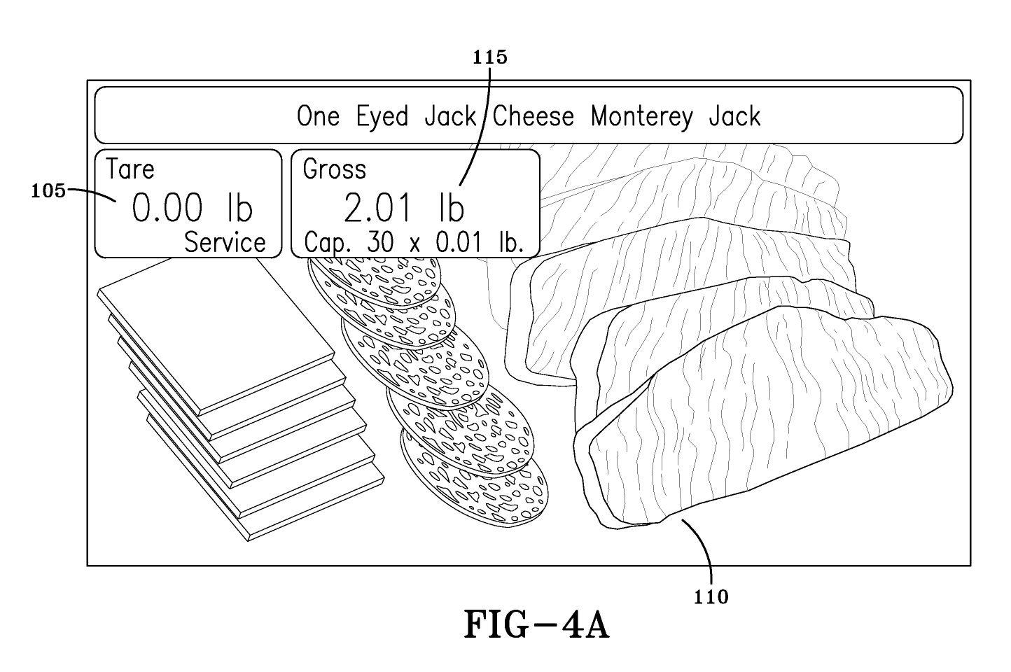

It is also to be understood that additional media content screens may be presented to an operator upon selecting a particular media content category from the list 85 of available media content. For example, if an operator presses the “Related Product Media” selection button 95 shown in FIG. 2B, one or more additional operator display screens (not shown for brevity) may be presented to permit the operator to choose from a number of different related media content options to push to the consumer display. This is exemplified in FIG. 3B and discussed in more detail below.

One exemplary embodiment of a typical display 100 that may appear on a consumer-facing display of a PC-based weighing scale is shown in FIG. 3A. The display 100 may be a default display or it may represent content selected for general (non-consumer specific) presentation by a scale operator or other store employee. This particular display 100 represents a static image, image slide show, or video that may be presented on the consumer display of the scale when the scale is not being used for a transaction and when an operator has not selected to push particular media content to a consumer. A zero indicator 105 (as required by law) is viewable over the display 100, but located such that a maximum amount of the consumer display screen is available to display other content. While the consumer-facing display 100 is shown for purposes of illustration, it would be obvious to one skilled in the art that such screens may be used to present many types of information in a variety of formats. For example, such a consumer screen may display product advertisements, store-related messages, coupons, recipes or a host of other content instead of a screen like that shown in FIG. 3A. Therefore, it is to be understood that the particular display shown in FIG. 3A is provided for purposes of illustration only.

FIG. 3B represents the consumer display screen of FIG. 3A after an operator has selected particular media content to push to the consumer. In this particular example, the operator has selected the “Related Media Content” option from the list 85 of available media content presented on the operator display screen of FIG. 2B. The operator has then selected to present a static image that includes rib eye steaks. As a result, the selected media content 110 is pushed to the consumer display screen and replaces the previously exhibited display 100 shown in FIG. 3A. The zero indicator 105 continues to be viewable despite the change in media content, as is required by law. A consumer may view the selectively presented media content 110 while waiting at the scale.

As with the other exemplary screen displays shown and described above, it should be obvious to one skilled in the art that the media content pushed to the consumer display by the scale operator may be of various format and may convey a variety of different information. For example, the pushed media content may be a recipe, a coupon, nutritional information, store information, or a host of other content similar to or different from the exemplary product image shown in FIG. 3B. The pushed media content may also be of different format, such as text only media content or video-based media content. Therefore, it is to be understood that the particular display screen shown in FIG. 3B is provided for purposes of illustration only. It should also be realized that the selection of media content may be performed solely at the discretion of the scale operator (e.g., based on an observation of the consumer, products selected by the consumer, or a dialogue with the consumer), may result from a scale-based prompt or other instruction/suggestion provided to the scale operator (such as regarding a particular promotion), may be in response to a query from a consumer, etc. In any event, however, the pushing of media content to the consumer display is controlled by the scale operator.

As discussed above, the present invention seeks to maximize the space available on the consumer display screen for presenting selected media content, while also ensuring that relevant and/or necessary information (e.g., zero weight reading, product weight, price/unit, total price, etc.) is also presented to the consumer. Known scale-related media content presentation systems and methods typically decrease the size of any displayed media content in order to present relevant or necessary information on a consumer display screen. These known systems and methods also typically display all relevant information at one time and/or maintain a blank or partially blank placeholder for said information on the consumer display screen at all times. This adversely affects the space available for presenting selected consumer media content and may also negatively impact the appearance and effectiveness of the displayed media content.

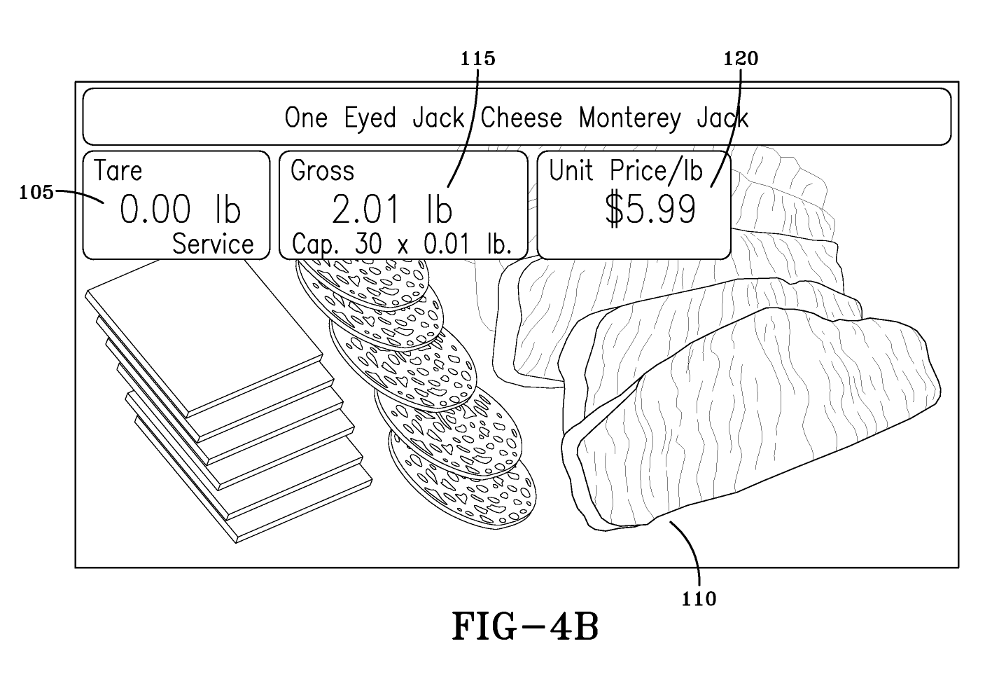

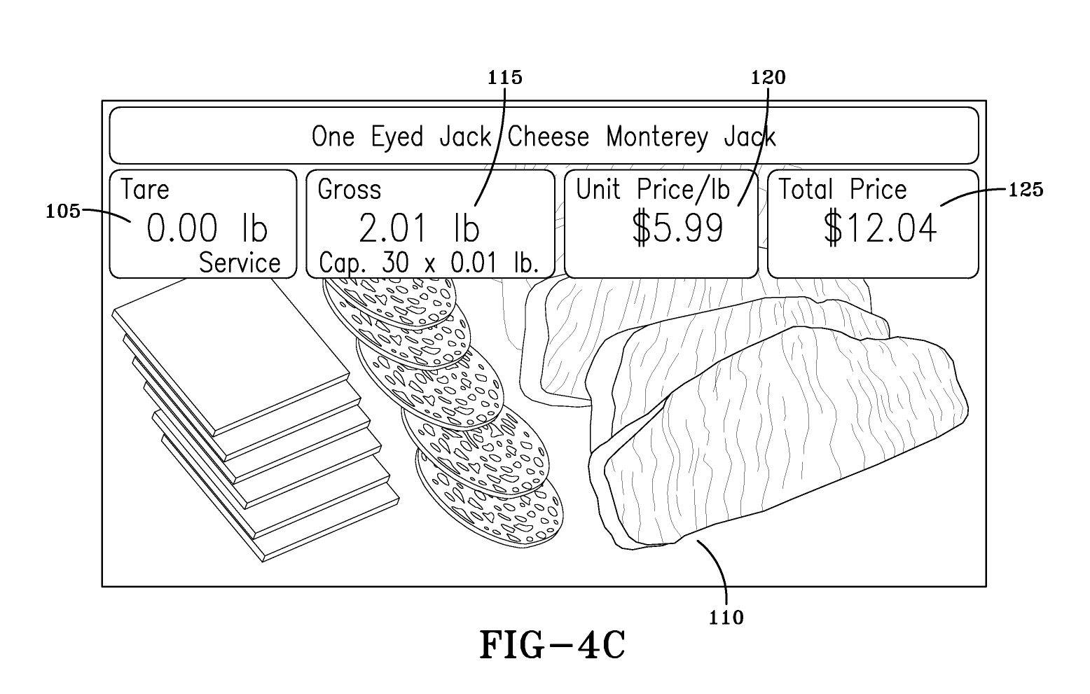

As illustrated in FIGS. 3B-4C, the present invention overcomes this problem by presenting relevant and necessary information in a real-time fashion, such that the information is not displayed until required and does not remain on the consumer display screen longer than necessary. That is, the present invention employs a build-up of information to maximize as much as possible the space available on the consumer display screen for presenting selected media content.

As described above, FIG. 3B represents an exemplary display of selected media content 110 just after a scale operator has made a selection as to what content to push to the consumer. As such, the display 110 has been substituted for the previous display 100 on the consumer display of the scale. A zero weight reading 105 overlies the displayed media content at the top left corner of the display screen in this example, although the zero weight reading could be otherwise located on the consumer display screen.

Referring now to FIG. 4A, the consumer display screen has been automatically updated to reflect the weight 115 of the product (rib eye steak, in this example) selected by the consumer and placed on the scale by the scale operator. The zero weight reading 105 continues to be displayed as well. FIG. 4B reflects the aforementioned build-up of additional information by adding the price/unit 120 of the selected product to the consumer display screen. FIG. 4C further illustrates this technique by finally adding the cost of the product 125 to the consumer display screen—although the cost of the product 125 could also be simultaneously displayed with the price/unit 120 of the selected product. As with the zero weight reading 105, this other information may be presented at locations other than those illustrated in the drawing figures. Items of relevant/necessary information may be presented in proximity to one another, or may be scattered around a given consumer display screen.

In this manner, the amount of space available on the consumer display screen for the uncorrupted presentation of selected media content is maximized to the extent and for as much time as possible. Additionally, once information such as the product weight 115, price/unit 120 and product cost 125 have been presented to the consumer for some adequate amount of time, the information may be automatically removed from the consumer display screen by the scale, leaving only the zero weight reading 105 and the previously selected media content display 110 (or the display of newly or additionally selected media content, a default display, etc.). Alternatively, the scale operator, rather than a timer, may cause such a removal of information after presentation to a consumer.

It should be realized that when selected media content other than static text or a static image (e.g., an image slide show or video) is presented to a consumer, playing of the selected media content is ongoing as the consumer display is updated with relevant and necessary information. Therefore, there is no interruption of the selected media content presentation other than the substantially unobtrusive addition of such information in a manner such as that illustrated and described above. Further, there is no need to present the selected media content in a reduced size to leave room for the presentation of relevant/necessary information or to reduce the size of the selected media content when such information is presented.

While FIGS. 3B-4C illustrate the presentation of relevant/necessary information by way of semi-transparent data boxes that overlie the display of selected media content, the present invention contemplates that such information may be alternately presented. For example, opaque or substantially opaque data boxes may be used, it is possible to cause the items of relevant/necessary information to fade in/out, or to otherwise be displayed in a manner that is legible but interferes as little as possible with the presentation of the selected media content.

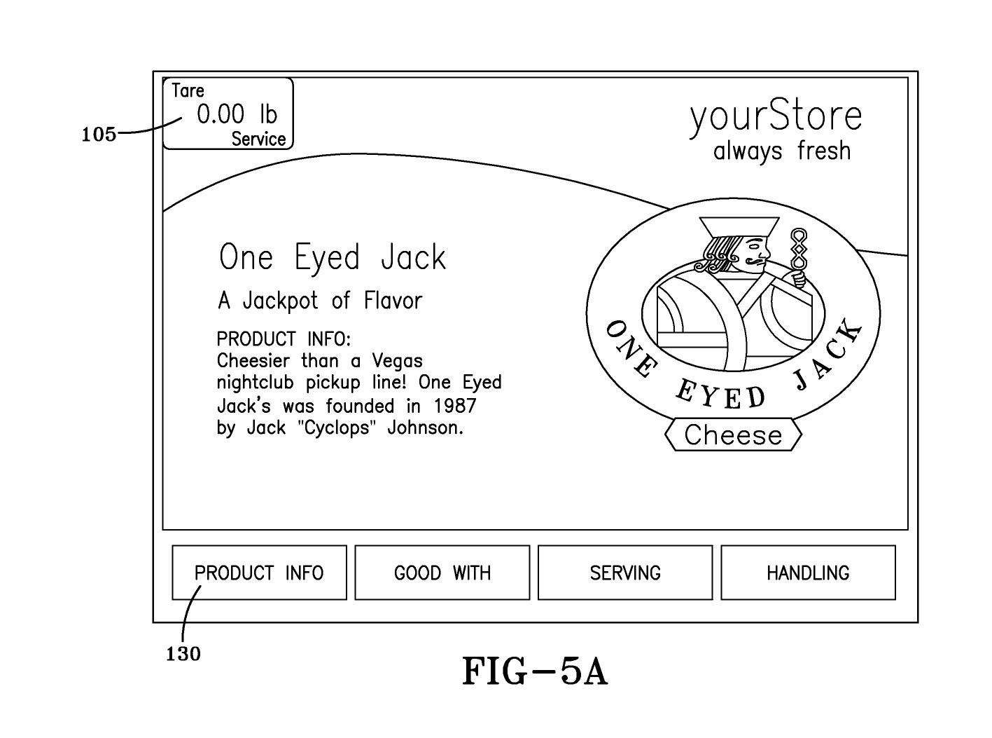

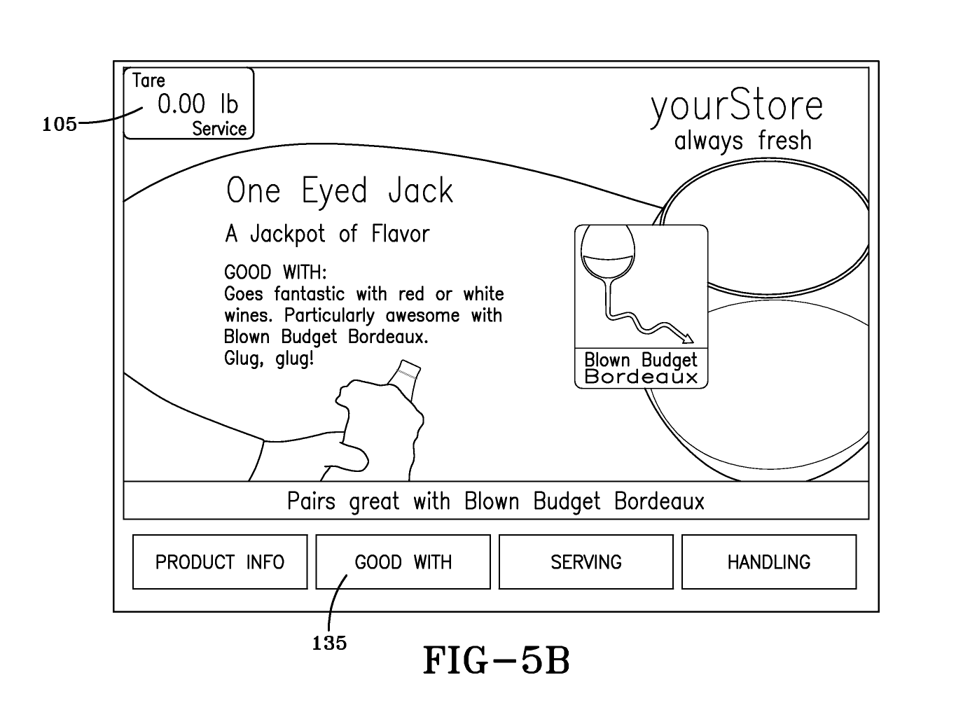

Further presentation of media content information to a consumer is illustrated in FIGS. 5A-5B. As shown in FIG. 5A, after the necessary information about the selected product and the weighing operation has been presented on the consumer display, the scale operator has elected to present the consumer with media content associated with a different product. In this particular example, the product associated with the newly presented media content was also referenced in the previously displayed media content, but this is optional. The product associated with the newly presented media content may be selected for any of various reasons, such as a store or manufacturer promotion, because it is a complimentary product to the product weighed on the scale or to another product the consumer has already selected, in response to a consumer query or comment, based on some observation of the consumer by the scale operator, etc. In this example, the product associated with the newly pushed media content is cheese, and a static image associated with the cheese replaces on the consumer display the previous static image showing rib eye steaks.

FIG. 5A also depicts a modified version of what may have been the original version of the media content image pushed to the consumer display by the scale operator. More particularly, it can be seen in FIG. 5A that a consumer has selected a “Product Info” button appearing along the bottom of the displayed image and, consequently, information about the cheese product also appears on the display.

FIG. 5B depicts yet other media content presented on the consumer display. In this case, the consumer has subsequently selected a “Good With” button appearing along the bottom of the displayed image and, as a result, new media content in the form of information relating to wines that might go well with the cheese product are displayed. Other optional selection buttons are also shown in this example. Unlike the previously discussed media content presented on the consumer display, this media content is selected by the consumer. However, as should be apparent, the consumer selections made available are at in least in part related to media content selections previously made by the scale operator.

While certain embodiments of the present invention are described in detail above, the scope of the invention is not to be considered limited by such disclosure, and modifications are possible without departing from the spirit of the invention as evidenced by the following claims:

What is claimed is:

1. A method of presenting selected media content to a consumer via a weighing scale, comprising:
providing a PC-based weighing scale programmed to permit operator selection of media content from a repository of media content with which said scale is in communication, said scale having an operator display screen viewable and usable by only a scale operator, and a consumer display screen;
requesting, via said operator display, the call up of media content from said repository of media content;
interrupting, at least partially, a current display on said operator display with a listing of available media content provided in response to said request;
selecting, via said operator display, particular media content from said listing of media content;
as a result of said selection, using a program of said scale to substitute said selected media content for a current display appearing on said consumer display screen; and
presenting, on said consumer display screen, a zero weight reading that is viewable at all times.

2. The method of claim 1, wherein the selection of media content is randomly performed by a scale operator.

3. The method of claim 1, wherein the selection of media content is based on the observation of a given consumer by a scale operator.

4. The method of claim 1, wherein the selection of media content is based on a query by a consumer.

5. The method of claim 1, wherein the selected media content is selected from the group consisting of text, images, video, audio, and combinations thereof.

6. The method of claim 1, further comprising automatically presenting, on said consumer display screen, other information deemed relevant or necessary, said other information presented in real-time as it becomes available without interrupting or reducing the size of the selected media content display.

7. The method of claim 6, further comprising removing, partially or entirely, said other information after presentation on said consumer display screen so as to maximize the available space for the presentation of selected media content.

8. The method of claim 6, wherein said zero weight reading and said other information deemed relevant or necessary are in the form of semi-transparent data boxes superimposed over media content displayed on said consumer display screen.

9. A method of presenting selected media content to a consumer via a weighing scale, comprising:
providing a PC-based weighing scale programmed to permit operator selection of media content from a repository of media content with which said scale is in communication, said scale having an operator display screen viewable and usable by only a scale operator, and a consumer display screen;
requesting, via said operator display, the call up of media content from said repository of media content;
interrupting, at least partially, a current display on said operator display with a listing of available media content provided in response to said request;
selecting, via said operator display, particular media content from said listing of media content;
as a result of said selection, using a program of said scale to substitute said selected media content for a current display appearing on said consumer display screen;
presenting, on said consumer display screen, a zero weight reading that is viewable at all times;
automatically presenting, on said consumer display screen, other information deemed relevant or necessary, said other information presented in real-time as it becomes available without interrupting or reducing the size of the selected media content display; and
removing, partially or entirely, said other information after presentation on said consumer display screen so as to maximize the available space for the presentation of selected media content.

10. The method of claim 9, wherein the selection of media content is randomly performed by a scale operator.

11. The method of claim 9, wherein the selection of media content is based on the observation of a given consumer by a scale operator.

12. The method of claim 9, wherein the selection of media content is based on a query by a consumer.

13. The method of claim 9, wherein the selected media content is selected from the group consisting of text, images, video, audio, and combinations thereof.

14. The method of claim 9, wherein said zero weight reading and said other information deemed relevant or necessary are in the form of semi-transparent data boxes superimposed over media content displayed on said consumer display screen.

15. A system for presenting selected media content to a consumer via a weighing scale, comprising:
a PC-based weighing scale having an operator display screen viewable and usable by only a scale operator, and a consumer display screen, a zero weight reading visible at all times on said consumer display screen;
a mechanism on said scale for permitting a scale operator to call up a collection of media content from a repository of media content with which said scale is in communication, and to select particular media content from said collection of media content for pushing to and displaying on said consumer display screen;
a software program on said scale, the program adapted to cause the substitution of said selected media content for a current display appearing on said consumer display screen, to automatically present on said consumer display screen non-media content information deemed relevant or necessary, said other information presented in real-time as it becomes available without interrupting or reducing the size of the selected media content display, and to remove, partially or entirely, said other information after presentation on said consumer display screen so as to maximize the available space for the presentation of selected media content.

16. The system of claim 15, wherein non-media content information is presented in the form of semi-transparent data boxes.

17. The system of claim 15, further comprising a content management system in communication with said scale, said repository of media content, and a source of media content.

18. The system of claim 17, wherein said content management system is adapted to transfer new and updated media content from said source of media content to said scale.

19. The system of claim 15, wherein said repository of media content is located on said scale.

20. The system of claim 15, wherein said repository of media content is located on a database in network communication with said scale.
